(19) United States
(12) Patent Application Publication
(10) Pub. No.: US 2026/0360944 A1
(43) Pub. Date: Nov. 12, 2026

(54) BATTERY CELL

(71) Applicant: SK On Co., Ltd., Seoul (KR)

(72) Inventors: Chang Mook HWANG, Daejeon (KR); Soo Bin PARK, Daejeon (KR); Jong Chan IM, Daejeon (KR)

(21) Appl. No.: 19/671,239

(22) Filed: May 8, 2026

(30) Foreign Application Priority Data
May 9, 2025 (KR) 10-2025-0060404

(51) Int. Cl. H01M 50/54; H01M 50/147; H01M 50/46; H01M 50/528; H01M 50/533

(52) U.S. Cl. CPC H01M 50/54; H01M 50/147; H01M 50/46; H01M 50/528; H01M 50/533

(57) ABSTRACT

A battery cell includes a plurality of electrode assemblies arranged side by side in a second direction intersecting a first direction, a case accommodating the plurality of electrode assemblies, and a current collector electrically connected to the plurality of electrode assemblies within the case. The plurality of electrode assemblies each includes a plurality of electrode plates, a separator disposed between the plurality of electrode plates, and a plurality of tab portions protruding from the plurality of electrode plates in the first direction and arranged side by side in the second direction. Each of the plurality of tab portions includes a first tab having a first inclination with respect to the first direction, and a second tab having a second inclination with respect to the first direction and electrically connected to the first tab. The first inclination and the second inclination differ from each other.

### CROSS-REFERENCE TO RELATED PATENT APPLICATION

This disclosure claims priority under 35 U.S.C. § 119(a) to Korean patent application number 10-2025-0060404, filed on May 9, 2025, the entire disclosure of which is incorporated by reference herein.

### TECHNICAL FIELD

Various aspects of this disclosure generally relate to a battery cell, and more particularly, to a battery cell having improved structural stability.

### DISCUSSION OF THE RELATED ART

A secondary battery may include an electrode assembly in which electrode plates are stacked or wound with a separator interposed therebetween, a case which accommodates the electrode assembly with an electrolyte, and a cap assembly which seals the case. Such an electrode assembly may have tab portions (uncoated tabs) protruding in a lateral or upward direction, and the tab portions may be gathered to one side and bent over a current collector, followed by laser welding the tab portions to the current collector. Alternatively, the tab portions may be gathered to one side, placed on the current collector, and pressed, followed by laser welding. However, when the number of electrode plates is large and the thickness of the tab portions gathered to one side is great, there may be difficulties in bending or pressing the tab portions for laser welding. To prevent or mitigate such difficulties, it is necessary to develop a structure capable of welding the tab portions without damaging the tab portions.

### SUMMARY

First, according to an aspect of this disclosure, an object is to improve the structural stability of a battery cell.

Second, according to another aspect of this disclosure, an object is to efficiently utilize the quality of the battery cell.

Third, according to still another aspect of this disclosure, an object is to improve the reliability of the battery cell.

Various aspects of this disclosure may be widely applied in the green technology fields such as electric vehicles, battery charging stations, energy storage systems (ESSs), and other technologies using batteries such as photovoltaics and wind power. In addition, various aspects of this disclosure may also be used for eco-friendly mobility, including electric and hybrid vehicles, to suppress or reduce air pollution and greenhouse gas emissions to prevent or mitigate climate change.

A battery cell according to this disclosure may include a plurality of electrode assemblies arranged side by side in a second direction intersecting a first direction, a case accommodating the plurality of electrode assemblies, and a current collector electrically connected to the plurality of electrode assemblies within the case. The plurality of electrode assemblies may each include a plurality of electrode plates, a separator disposed between the plurality of electrode plates, and a plurality of tab portions protruding from the plurality of electrode plates in the first direction and arranged side by side in the second direction. Each of the plurality of tab portions may include a first tab having a first inclination with respect to the first direction, and a second tab having a second inclination with respect to the first direction and electrically connected to the first tab. The first inclination and the second inclination may differ from each other.

In an aspect, the current collector may be disposed between a pair of electrode assemblies disposed at outermost sides in the second direction.

In an aspect, one of the first tab and the second tab may be closer to the current collector than the other of the first tab and the second tab.

In an aspect, one or more of the first tab and the second tab may have a curved surface in at least a portion thereof.

In an aspect, the plurality of electrode assemblies may further include another pair of electrode assemblies arranged between a pair of electrode assemblies disposed at outermost sides in the second direction.

In an aspect, the current collector and the other pair of electrode assemblies may overlap each other in the first direction.

In an aspect, the plurality of tab portions may form a tab bundle in which the plurality of tab portions contact each other.

In an aspect, the tab bundle may be electrically connected to the current collector.

In an aspect, the tab bundle may be bent in a direction toward the current collector and welded to the current collector.

In an aspect, the tab portions of the pair of electrode assemblies disposed at the outermost sides in the second direction may be disposed side by side in the second direction.

In an aspect, the tab portions of another pair of electrode assemblies disposed between the pair of electrode assemblies may be disposed side by side in the second direction.

In an aspect, the tab portions of the pair of electrode assemblies disposed at the outermost sides in the second direction may be spaced apart from the tab portions of another pair of electrode assemblies disposed between the pair of electrode assemblies, in a third direction intersecting the first direction and the second direction.

In an aspect, the plurality of tab portions of the plurality of electrode assemblies may be spaced apart from each other in a third direction intersecting the first direction and the second direction.

In an aspect, the plurality of tab portions may include a first tab portion disposed at one of outermost sides in the second direction, a second tab portion disposed at the other of the outermost sides in the second direction, a third tab portion disposed between the first tab portion and the second tab portion and adjacent to the first tab portion, and a fourth tab portion disposed between the first tab portion and the second tab portion and adjacent to the second tab portion.

In an aspect, the first tab portion and the second tab portion may each be bent twice in different directions.

In an aspect, the third tab portion and the fourth tab portion may each be bent twice in the same direction.

In an aspect, the first tab of the first tab portion may be disposed inward of the second tab of the first tab portion in the second direction, the first tab of the second tab portion may be disposed inward of the second tab of the second tab portion in the second direction, the first inclination of the first tab of the first tab portion may be less than the second inclination of the second tab of the first tab portion, and the first inclination of the first tab of the second tab portion may be less than the second inclination of the second tab of the second tab portion.

In an aspect, the first tab of the third tab portion may be disposed outward of the second tab of the third tab portion in the second direction, the first tab of the fourth tab portion may be disposed outward of the second tab of the fourth tab portion in the second direction, the first inclination of the first tab of the third tab portion may be less than the second inclination of the second tab of the third tab portion, and the first inclination of the first tab of the fourth tab portion may be less than the second inclination of the second tab of the fourth tab portion.

In an aspect, the case may include an accommodating body including an opening in one surface thereof and accommodating the electrode assemblies through the opening, and a cap assembly coupled to the accommodating body to cover the opening.

In an aspect, the current collector may include a first portion electrically connected to the plurality of tab portions, and a second portion bent from the first portion and electrically connected to the cap assembly.

First, according to an aspect of this disclosure, the structural stability of a battery cell may be improved.

Second, according to another aspect of this disclosure, the quality of the battery cell may be efficiently utilized.

Third, according to still another aspect of this disclosure, the reliability of the battery cell may be improved.

### BRIEF DESCRIPTION OF THE DRAWINGS

A more complete appreciation of this disclosure and many of the attendant aspects thereof will be readily obtained as the same becomes better understood by reference to the following detailed description when considered in connection with the accompanying drawings, wherein:

FIG. 1 is an exploded perspective view schematically illustrating a battery assembly according to an aspect of this disclosure;

FIG. 2 is a perspective view schematically illustrating a bent form of a tab bundle of a plurality of electrode assemblies according to an aspect of this disclosure;

FIG. 3 is a perspective view schematically illustrating a plurality of electrode assemblies according to an aspect of this disclosure;

FIG. 4 is a plan view schematically illustrating a portion of a battery cell according to an aspect of this disclosure;

FIG. 5 is an enlarged view of portion A of FIG. 4;

FIG. 6 is a side view schematically illustrating a battery cell according to an aspect of this disclosure;

FIG. 7 is a side view schematically illustrating a modified aspect of FIG. 6;

FIG. 8 is a side view schematically illustrating a further aspect of FIG. 6;

FIG. 9 is a side view schematically illustrating still another aspect of FIG. 6; and

FIG. 10 is a side view schematically illustrating yet another aspect of FIG. 6.

### DETAILED DESCRIPTION

Hereinafter, this disclosure will be described in detail with reference to the accompanying drawings. Configurations and control methods of an apparatus described below are provided only for the purpose of illustrating aspects of this disclosure and are not necessarily intended to limit the scope of this disclosure. Throughout the specification, like reference numerals refer to like components.

In this disclosure, the term "battery cell" may refer to a secondary battery, a cell, or a battery, and these terms may be used interchangeably.

In this disclosure, the term "battery system" may refer to one of a battery module, a battery pack, and an energy storage system (ESS), each including at least one battery stack in which a plurality of battery cells are grouped.

In this disclosure, an X-direction may correspond to a protruding direction of a tab portion of an electrode assembly (or a first direction), a Y-direction may correspond to a stacking direction of the electrode assembly (or a second direction), and a Z-direction may correspond to a direction intersecting both the X and Y-directions (or a third direction).

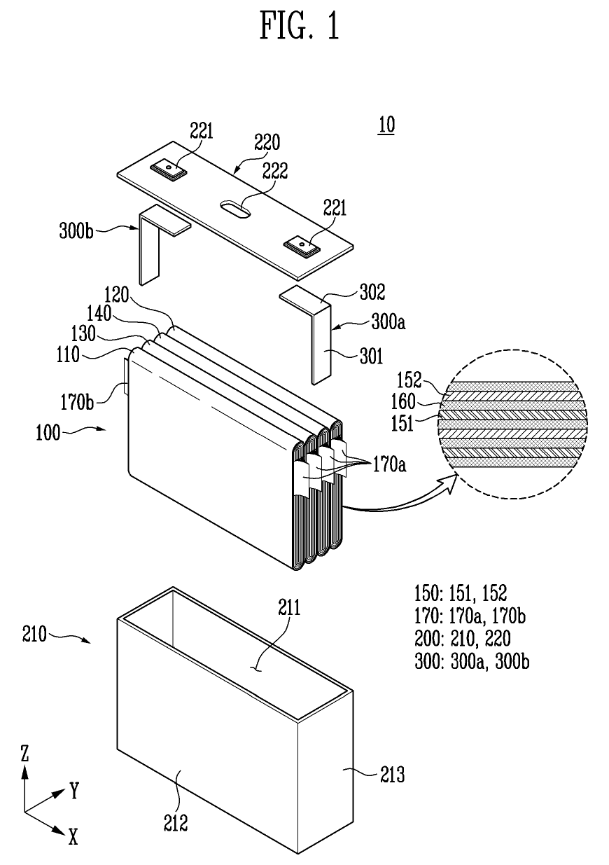

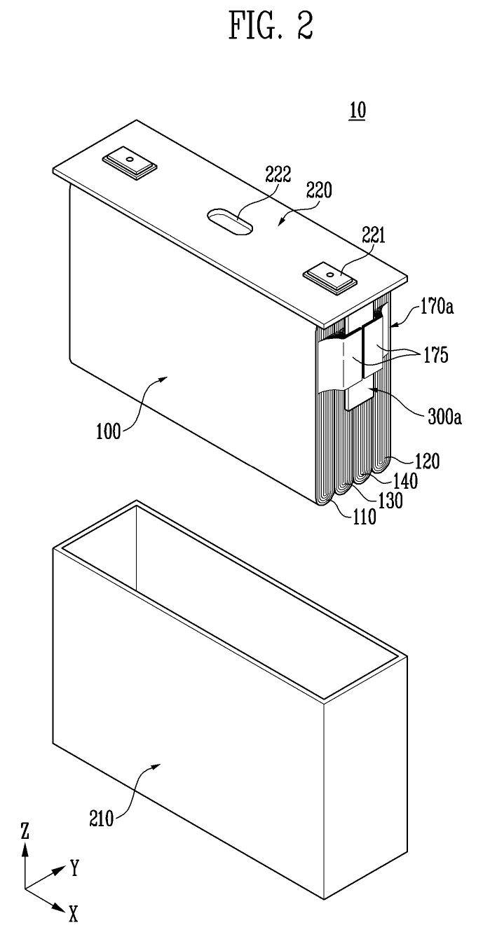

FIG. 1 is an exploded perspective view schematically illustrating a battery assembly according to an aspect of this disclosure. FIG. 2 is a perspective view schematically illustrating a bent form of a tab bundle of a plurality of electrode assemblies according to an aspect of this disclosure.

Referring to FIGS. 1 and 2 together, a battery cell 10 according to an aspect of this disclosure may include a plurality of electrode assemblies 100, a case 200, and a current collector 300.

The battery cell 10 may be a prismatic battery with the case 200 having a rectangular parallelepiped shape. However, this is merely an example, and this disclosure may be applied to battery cells having cases of various shapes.

The plurality of electrode assemblies 100 may include a first electrode assembly 110 disposed at one of outermost sides in a second direction (Y), a second electrode assembly 120 disposed at the other of the outermost sides in the second direction (Y), a third electrode assembly 130 disposed adjacent to the first electrode assembly 110 between the first and second electrode assemblies 110 and 120, and a fourth electrode assembly 140 disposed adjacent to the second electrode assembly 120 between the first and second electrode assemblies 110 and 120.

Each of the plurality of electrode assemblies 100 may include a plurality of electrode plates 150, a separator 160 disposed between the plurality of electrode plates 150, and a plurality of tab portions 170 protruding from the plurality of electrode plates 150 in a first direction (X) and arranged side by side in the second direction (Y) intersecting the first direction (X). The plurality of electrode assemblies 100 may be arranged side by side in the second direction (Y).

The plurality of electrode plates 150 may include a first electrode 151, and a second electrode 152 having a different polarity from the first electrode 151. For example, the first electrode 151 may be one of a positive electrode plate and a negative electrode plate, and the second electrode 152 may be the other of the positive electrode plate and the negative electrode plate having a different polarity from the first electrode 151. The separator 160 may electrically separate the first electrode 151 and the second electrode 152 between the first electrode 151 and the second electrode 152.

The electrode assembly 100 may have a shape in which the first electrode 151, the separator 160, and the second electrode 152 are wound in a flattened shape. For example, the electrode assembly 100 may have a shape in which the first electrode 151, the separator 160, and the second electrode 152 are stacked along the second direction (Y), but aspects are not necessarily limited thereto.

The plurality of tab portions 170 may protrude from the plurality of electrode plates 150 in the first direction (X) and may be arranged side by side in the second direction (Y) intersecting the first direction (X).

Each of the plurality of tab portions 170 may include a first tab portion 170a protruding from the first electrode 151 and a second tab portion 170b protruding from the second electrode 152. Although FIG. 1 illustrates an example in which the first tab portions 170a and the second tap portions 170b protrude in opposite directions relative to the first direction (X), aspects might not necessarily be limited thereto. For example, the first tab portions 170a and the second tab portions 170b may protrude in the same direction.

When the first electrode 151 is the negative electrode plate, the first electrode 151 may be formed by applying a first electrode active material, such as graphite or carbon, to a first electrode current collector provided as a metal foil, such as copper, a copper alloy, nickel, or a nickel alloy. The first electrode 151 may include a first uncoated portion which is a region to which the first electrode active material is not applied. The first uncoated portion serves as a tab electrically connected to a first current collector 300a, which may be disposed at one side of the battery cell 10 in opposite directions, and thus the first uncoated portion may be defined as the tab portion 170a.

A plurality of first tab portions 170a may form a tab bundle 175 in which the plurality of first tab portions 170a contact each other. The tab bundle 175 may be electrically connected to the first current collector 300a. For example, the tab bundle 175 may be bent in a direction toward the first current collector 300a and welded to the first current collector 300a (see FIGS. 2-4). The first current collector 300a may be electrically connected to a cap assembly 220.

When the second electrode 152 is the positive electrode plate, the second electrode 152 may be formed by applying a second electrode active material, such as a transition metal oxide, to a second current collector provided as a metal foil, such as aluminum or an aluminum alloy. The second electrode 152 may include a second uncoated portion which is a region to which the second electrode active material is not applied. The second uncoated portion serves as a tab electrically connected to a second current collector 300b, which may be disposed at the other side of the battery cell 10 in the opposite directions and disposed at a side opposite to the first current collector 300a, and thus the second uncoated portion may be defined as the tab portion 170b.

A plurality of second tab portions 170b may form the tab bundle 175 in which the plurality of second tab portions 170b contact each other. The tab bundle 175 may be electrically connected to the second current collector 300b. For example, the tab bundle 175 may be bent in a direction toward the second current collector 300b and welded to the second current collector 300b (see FIGS. 2-4). The second current collector 300b may be electrically connected to the cap assembly 220.

The separator 160 may be disposed between the first electrode 151 and the second electrode 152 to prevent or mitigate a short circuit and allow migration of lithium ions. For example, the separator 160 may include a porous polymer film, for example, a porous polymer film made of a polyolefin-based polymer, such as an ethylene homopolymer, a propylene homopolymer, an ethylene/butene copolymer, an ethylene/hexene copolymer, or an ethylene/methacrylate copolymer, and may be used alone or in a stacked structure of two or more thereof. As another example, the separator 160 may include a conventional porous nonwoven fabric, for example, a nonwoven fabric formed of high-melting-point glass fibers, polyethylene terephthalate fibers, or the like.

The plurality of electrode assemblies 100 may be formed by winding the first electrode 151, the second electrode 152, and the separator 160 interposed between the first electrode 151 and the second electrode 152 about a winding axis extending in a direction (X) in which the first tab portion 170a or the second tab portion 170b protrudes, and then pressing the same to form a flat and planar prismatic shape, as shown in FIG. 1.

Outer surfaces of each of the plurality of electrode assemblies 100 may include two surfaces each disposed parallel to the winding axis, two curved surfaces curved between the two surfaces, and side surfaces disposed perpendicular to a longitudinal direction while being formed by stacking a plurality of end portions of the electrode plates and the separator to define a surface. In addition, the outer surface of each of the plurality of electrode assemblies 100 may be provided with an additional separator for insulation from the case 200. However, in aspects, the outer surfaces of the plurality of electrode assemblies 100 are not limited thereto.

The plurality of electrode assemblies 100 may be accommodated in the case 200 with an electrolyte solution. For example, the electrolyte solution may include a lithium salt, such as LiPF₆ or LiBF₄, in an organic solvent, such as ethylene carbonate (EC), propylene carbonate (PC), diethyl carbonate (DEC), ethyl methyl carbonate (EMC), or dimethyl carbonate (DMC). Further, the electrolyte solution may be in a liquid or gel state. In another aspect, the electrolyte solution may be omitted when an inorganic solid electrolyte is used.

The case 200 may have a substantially rectangular box shape and may accommodate the plurality of electrode assemblies 100. The case 200 may include an accommodating body 210 and the cap assembly 220.

The accommodating body 210 may include an opening 211 in one surface thereof and may accommodate the electrode assemblies 100 through the opening 211. The cap assembly 220 may be coupled to the accommodating body 210 to cover the opening 211.

The accommodating body 210 may define an internal space. Through the opening 211, the plurality of electrode assemblies 100 and the electrolyte solution may be accommodated in the internal space of the case 200. Some configurations of the cap assembly 220 may be exposed to the outside of the accommodating body 210, and the remaining configurations, excluding some configurations, may be accommodated in the internal space of the accommodating body 210.

When, among side surfaces of the accommodating body 210, a surface having a relatively large area is defined as a long side portion 212 and a surface having a relatively small area is defined as a short side portion 213, one outer surface of the first electrode assembly 110 among the plurality of electrode assemblies 100 may be disposed to face the long side portion 212. Further, the third electrode assembly 130 may be disposed adjacent to the first electrode assembly 110 in the second direction (Y) while facing the first electrode assembly 110. Further, the fourth electrode assembly 140 and the second electrode assembly 120 may be sequentially disposed adjacent to the third electrode assembly 130.

Among the plurality of electrode assemblies 100, the first and second electrode assemblies 110 and 120 may be disposed at the outermost sides in the second direction (Y), and the third and fourth electrode assemblies 130 and 140 may be disposed between the first and second electrode assemblies 110 and 120 disposed at the outermost sides in the second direction (Y). Although FIGS. 1, FIG. 2, and the like illustrate that four electrode assemblies 100 are included in the battery cell 10, aspects might not necessarily be limited thereto. For example, the plurality of electrode assemblies 100 may include an even number of four or more.

With the plurality of electrode assemblies 100 accommodated in the accommodating body 210, the cap assembly 220 may be coupled to the accommodating body 210 and electrically connected to the plurality of electrode assemblies 100.

The cap assembly 220 may have a shape corresponding to a shape of the opening 211, and may include substantially the same material as the accommodating body 210. The cap assembly 220 may include a plurality of terminal portions 221 electrically connected to the current collector 300, and an electrolyte injection hole 222 for injecting the electrolyte solution.

An insulating plate (not shown) may be provided between the plurality of electrode assemblies 100 and the cap assembly 220 to insulate the plurality of electrode assemblies 100 from the cap assembly 220. However, aspects are not limited thereto.

The current collector 300 may be electrically connected to the plurality of electrode assemblies 100 within the case 200. The current collector 300 may include substantially the same material as the electrode plates 150. The current collector 300 may electrically connect the first electrode 151 or the second electrode 152 to the terminal portion 221 of the cap assembly 220.

The current collector 300 may have an L-shape. The current collector 300 may include a first portion 301 electrically connected to the plurality of tab portions 170 and a second portion 302 bent from the first portion 301 and electrically connected to the cap assembly 220. In other words, the first portion 301 of the current collector 300 may contact the plurality of tab portions 170 and the second portion 302 may contact the terminal portion 221. Accordingly, the current collector 300 may electrically connect the tab portions 170, which protrude toward opposite sides of the electrode plate 150 relative to the first direction (X), to the terminal portion 221 of the cap assembly 220 disposed above (in the Z-direction) of the electrode assembly 100.

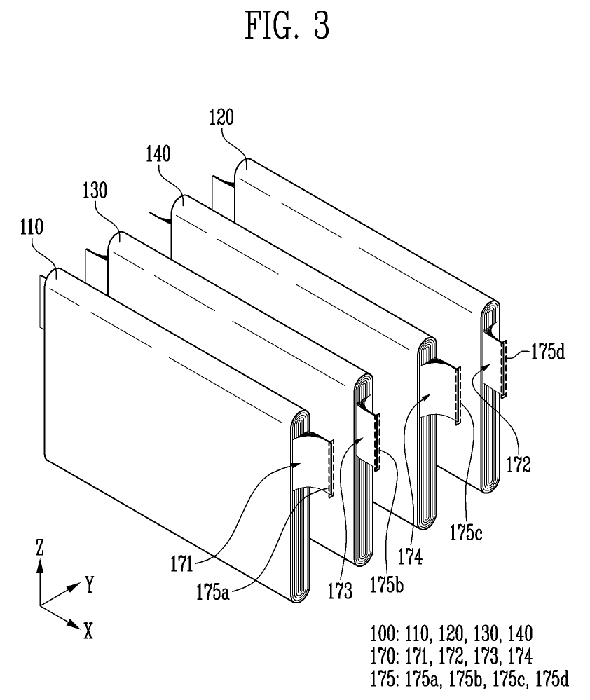

FIG. 3 is a perspective view schematically illustrating a plurality of electrode assemblies according to an aspect of this disclosure.

For example, FIG. 3 is a view illustrating the plurality of electrode assemblies 100 before being welded to the current collector 300.

Referring to FIGS. 2 and 3 together, the plurality of tab portions 170 may include a first tab portion 171 disposed at one of the outermost sides in the second direction (Y), a second tab portion 172 disposed at the other of the outermost sides in the second direction (Y), a third tab portion 173 disposed between the first tab portion 171 and the second tab portion 172 and adjacent to the first tab portion 171, and a fourth tab portion 174 disposed between the first tab portion 171 and the second tab portion 172 and adjacent to the second tab portion 172.

The plurality of tab portions 170 of each of the plurality of electrode assemblies 100 may form the tab bundle 175 in which the plurality of tab portions 170 contact each other. The tab bundle 175 may be electrically connected to the current collector 300. The tab bundle 175 may be bent in a direction toward the current collector 300 and welded to the current collector 300. For example, the tab bundle 175 may be electrically connected to a surface of the current collector 300 via laser welding.

Stated differently, a plurality of tab bundles 175 may be formed by gathering the plurality of tab portions 170 of each of the plurality of electrode assemblies 100 to weld the plurality of tab portions 170 to the current collector 300. For example, first tab portions 171 of the first electrode assembly 110 may form a first tab bundle 175a in which the first tab portions 171 contact each other. Second tab portions 172 of the second electrode assembly 120 may form a second tab bundle 175b in which the second tab portions 172 contact each other. Third tab portions 173 of the third electrode assembly 130 may form a third tab bundle 175c in which the third tab portions 173 contact each other. Fourth tab portions 174 of the fourth electrode assembly 140 may form a fourth tab bundle 175d in which the fourth tab portions 174 contact each other.

A portion of each of the first to fourth tab bundles 175a, 175b, 175c, and 175d, which is relatively distant from each of the electrode assemblies 100 in the first direction (X), may be bent in a direction toward the current collector 300 to weld the first to fourth tab bundles 175a, 175b, 175c, and 175d onto a surface of the current collector 300. As used herein, the term "bending" may include not only a meaning in which a planar surface is folded or bent, but also a meaning in which the planar surface is curved or bowed to have a curved surface.

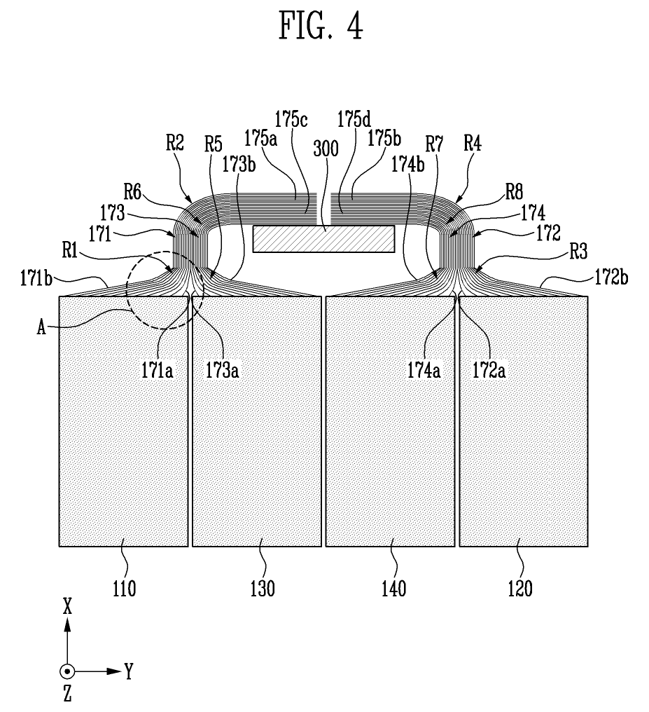

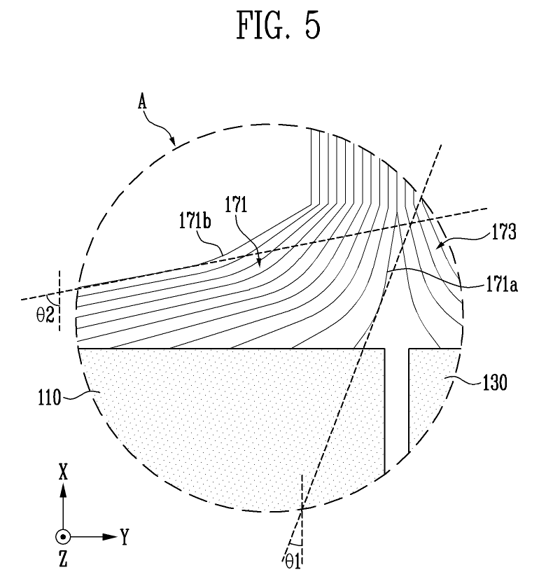

FIG. 4 is a plan view schematically illustrating a portion of a battery cell according to an aspect of this disclosure. FIG. 5 is an enlarged view of portion A of FIG. 4.

For example, FIG. 4 may be a plan view of the battery cell of FIG. 2 as viewed in the Z-direction. In addition, FIG. 4 may be a plan view illustrating the plurality of electrode assemblies 100 and the current collector 300, and showing a state in which the plurality of electrode assemblies 100 are welded to the current collector 300.

Referring to FIG. 4, the current collector 300 may be disposed between the first and second electrode assemblies 110 and 120, which form a pair of electrode assemblies disposed at the outermost sides in the second direction (Y). For example, the current collector 300 may be disposed between the first electrode assembly 110 and the second electrode assembly 120. Stated differently, the current collector 300 and another pair of electrode assemblies 130 and 140 may overlap in the first direction (X). For example, the current collector 300 may overlap the third electrode assembly 130 and the fourth electrode assembly 140 in the first direction (X). Stated differently, the current collector 300 may be disposed in the center of the case 200 along the second direction (Y), but aspects are not necessarily limited thereto.

Referring to FIGS. 4 and 5 together, each of the plurality of tab portions 170 may include a first tab 171a, 172a, 173a, or 174a having a first inclination θ1 with respect to the first direction (X), and a second tab 171b, 172b, 173b, or 174b having a second inclination θ2 with respect to the first direction (X) and electrically connected to a corresponding one of the first tabs 171a, 172a, 173a, and 174a.

In other words, the first tab portion 171 may include the first tab 171a having the first inclination θ1 with respect to the first direction (X), and the second tab 171b having the second inclinationθ2 with respect to the first direction (X) and electrically connected to the first tab 171a. The second tab portion 172 may include the first tab 172a having the first inclination θ1 with respect to the first direction (X), and the second tab 172b having the second inclination θ2 with respect to the first direction (X) and electrically connected to the first tab 172a. The third tab portion 173 may include the first tab 173a having the first inclination θ1 with respect to the first direction (X), and the second tab 173b having the second inclination θ2 with respect to the first direction (X) and electrically connected to the first tab 173a. The fourth tab portion 174 may include the first tab 174a having the first inclination θ1 with respect to the first direction (X), and the second tab 174b having the second inclination θ2 with respect to the first direction (X) and electrically connected to the first tab 174a.

The first inclination θ1 and the second inclination θ2 may differ from each other because distances between each of the first tab 171a, 172a, 173a, or 174a and the second tab 171b, 172b, 173b, or 174b and the current collector 300 differ from each other. Stated differently, in each pair of the first tab 171a, 172a, 173a, or 174a and the second tab 171b, 172b, 173b, or 174b, one of the first tab 171a, 172a, 173a, or 174a and the second tab 171b, 172b, 173b, or 174b may be closer to the current collector 300 than the other of the first tab 171a, 172a, 173a, or 174a and the second tab 171b, 172b, 173b, or 174b. For example, the first tabs 171a and 172a of the first and second tab portions 171 and 172 may be closer to the current collector 300 than the second tabs 171b and 172b, and the second tabs 173b and 174b of the third and fourth tab portions 173 and 174 may be closer to the current collector 300 than the first tabs 173a and 174a.

Each of the first tabs 171a, 172a, 173a, and 174a and the second tabs 171b, 172b, 173b, and 174b may be bent in a direction toward the current collector 300. In other words, one or more of the first tabs 171a, 172a, 173a, and 174a and the second tabs 171b, 172b, 173b, and 174b may have a curved surface in at least a portion thereof.

In aspects, although the first inclination θ1 of each of the first tabs 171a, 172a, 173a, and 174a with respect to the first direction (X) may differ from each other, for convenience of description, the following description assumes that all first inclinations θ1 are identical, since the differences in value are substantially negligible. Similarly, although the second inclination θ2 of each of the second tabs 171b, 172b, 173b, and 174b with respect to the first direction (X) may differ from each other, for convenience of description, the following description assumes that all second inclinations θ2 are identical, since the differences in value are substantially negligible.

The first tab 171a of the first tab portion 171 may be disposed inward of the second tab 171b of the first tab portion 171 in the second direction (Y). The first tab 172a of the second tab portion 172 may be disposed inward of the second tab 172b of the second tab portion 172 in the second direction (Y). In aspects, the first inclination θ1 of the first tab 171a of the first tab portion 171 may be less than the second inclination θ2 of the second tab 171b of the first tab portion 171. Similarly, a first inclination (not shown) of the first tab 172a of the second tab portion 172 may be less than a second inclination (not shown) of the second tab 172b of the second tab portion 172.

The first tab 173a of the third tab portion 173 may be disposed outward of the second tab 173b of the third tab portion 173 in the second direction (Y). The first tab 174a of the fourth tab portion 174 may be disposed outward of the second tab 174b of the fourth tab portion 174 in the second direction (Y). In aspects, a first inclination (not shown) of the first tab 173a of the third tab portion 173 may be less than a second inclination (not shown) of the second tab 173b of the third tab portion 173. Similarly, a first inclination (not shown) of the first tab 174a of the fourth tab portion 174 may be less than a second inclination (not shown) of the second tab 174b of the fourth tab portion 174.

The first tab portion 171 of the first electrode assembly 110 and the second tab portion 172 of the second electrode assembly 120 may each be bent twice in different directions. For example, the first tab portion 171 may be bent once in a counterclockwise direction to form a bend R1, and then bent once more in a clockwise direction to form a bend R2 on a path extending from the first electrode assembly 110 to the current collector 300. Similarly, the second tab portion 172 may be bent once in a clockwise direction to form a bend R3, and then bent once more in a counterclockwise direction to form a bend R4 on a path extending from the second electrode assembly 120 to the current collector 300. Stated differently, the first tab portion 171 and the second tab portion 172 may each be bent twice to have an S-shape.

The third tab portion 173 of the third electrode assembly 130 and the fourth tab portion 174 of the fourth electrode assembly 140 may each be bent twice in the same direction. For example, the third tab portion 173 may be bent once in a clockwise direction to form a bend R5, and then bent once more in a clockwise direction to form a bend R6 on a path extending from the third electrode assembly 130 to the current collector 300. Similarly, the fourth tab portion 174 may be bent once in a counterclockwise direction to form a bend R7, and then bent once more in a counterclockwise direction to form a bend R8 on a path extending from the fourth electrode assembly 140 to the current collector 300. Stated differently, the third tab portion 173 and the fourth tab portion 174 may each be bent twice to have a C-shape.

The battery cell 10 may include four or more electrode assemblies 100, thereby reducing the thickness of the tab bundle 175 formed by the tab portions 170 included in each electrode assembly 100. Further, by bending the tab bundles 175 of adjacent electrode assemblies 100 in different directions among the four electrode assemblies 100, the tab portions 170 may be easily bent in a direction toward the current collector 300.

Further, the first and second tab portions 171 and 172 of the first and second electrode assemblies 110 and 120 of the battery cell 10 disposed at the outermost sides in the second direction (Y) are bent toward the current collector 300 and have a curved surface in at least a portion thereof, thereby increasing the length of the tab portion 170 in the stacking direction (Y, e.g., the second direction) without damaging the tab portion 170 (e.g., tearing the tab portion) even when the electrode assembly 100 expands. Accordingly, the structural stability and reliability of the battery cell 10 may be improved.

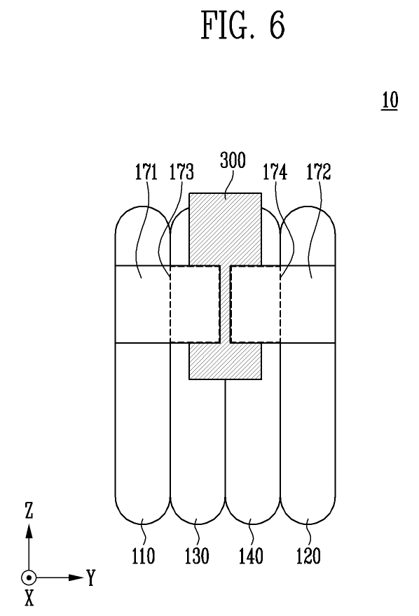

FIG. 6 is a side view schematically illustrating a battery cell according to an aspect of this disclosure.

FIG. 6 may be a side view of the battery cell of FIG. 2 as viewed in the X-direction. For example, FIG. 6 may be a side view illustrating the plurality of electrode assemblies 100 and the current collector 300, and showing a state in which the plurality of electrode assemblies 100 are welded to the current collector 300.

Referring to FIG. 6, the tab portions 170 of the plurality of electrode assemblies 100 disposed in the second direction (Y) may be disposed side by side in the second direction (Y).

For example, the first and second tab portions 171 and 172 of the first and second electrode assemblies 110 and 120, which form a pair of electrode assemblies disposed at the outermost sides in the second direction (Y), may be disposed side by side in the second direction (Y). Further, the third and fourth tab portions 173 and 174 of the third and fourth electrode assemblies 130 and 140, which form another pair of electrode assemblies disposed between the first and second electrode assemblies 110 and 120 disposed at the outermost sides, may be disposed side by side in the second direction (Y). In other words, the first to fourth tab portions 171, 172, 173, and 174 may be disposed at the same position along a third direction (Z).

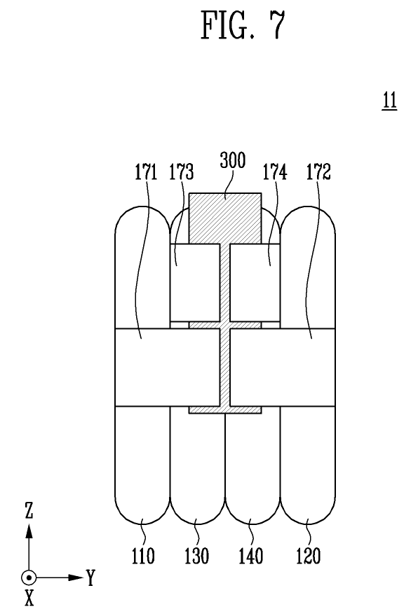

FIG. 7 is a side view schematically illustrating a modified aspect of FIG. 6.

Referring to FIG. 7, in a battery cell 11 according to a modified aspect, the first and second tab portions 171 and 172 of the first and second electrode assemblies 110 and 120, which form a pair of electrode assemblies disposed at the outermost sides in the second direction (Y), may be disposed side by side in the second direction (Y). Further, the third and fourth tab portions 173 and 174 of the third and fourth electrode assemblies 130 and 140, which are disposed between the first and second electrode assemblies 110 and 120 disposed at the outermost sides, may be disposed side by side in the second direction (Y).

The first and second tab portions 171 and 172 of the first and second electrode assemblies 110 and 120 may be spaced apart from the third and fourth tab portions 173 and 174 of the third and fourth electrode assemblies 130 and 140 in the third direction (Z) intersecting the first direction (X) and the second direction (Y). For example, the first and second tab portions 171 and 172 might not overlap the third and fourth tab portions 173 and 174 in the second direction (Y). In other words, the first and second tab portions 171 and 172 may be disposed at different positions from the third and fourth tab portions 173 and 174 in the third direction (Z).

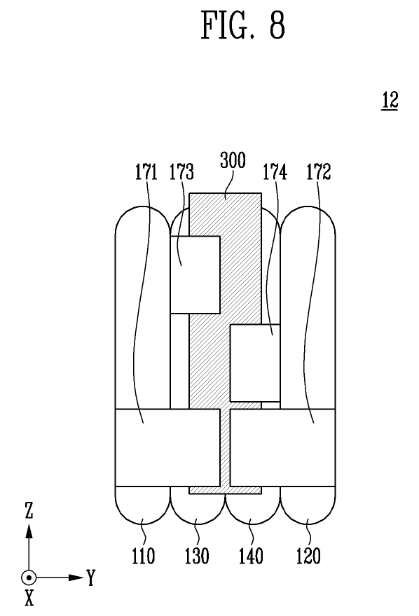

FIG. 8 is a side view schematically illustrating a further aspect of FIG. 6.

Referring to FIG. 8, in a battery cell 12 according to a further aspect, the first and second tab portions 171 and 172 of the first and second electrode assemblies 110 and 120, which form a pair of electrode assemblies disposed at the outermost sides in the second direction (Y), may be disposed side by side in the second direction (Y). The third and fourth tab portions 173 and 174 of the third and fourth electrode assemblies 130 and 140, which are disposed between the first and second electrode assemblies 110 and 120 disposed at the outermost sides, may be spaced apart from each other in the third direction (Z). For example, the third and fourth tab portions 173 and 174 might not overlap each other in the second direction (Y). In other words, the third and fourth tab portions 173 and 174 may be disposed at different positions in the third direction (Z).

Further, the first and second tab portions 171 and 172 may be spaced apart from the third and fourth tab portions 173 and 174 in the third direction (Z). For example, the first and second tab portions 171 and 172 may be disposed at different positions from each of the third and fourth tab portions 173 and 174 in the third direction (Z).

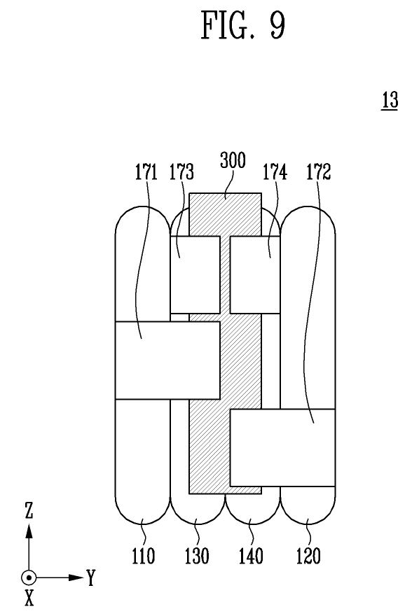

FIG. 9 is a side view schematically illustrating still another aspect of FIG. 6.

Referring to FIG. 9, in a battery cell 13 according to still another aspect, the third and fourth tab portions 173 and 174 of the third and fourth electrode assemblies 130 and 140, which are disposed between the first and second electrode assemblies 110 and 120 disposed at the outermost sides in the second direction (Y), may be disposed side by side in the second direction (Y). The first and second tab portions 171 and 172 may be spaced apart from each other in the third direction (Z). For example, the first and second tab portions 171 and 172 might not overlap each other in the second direction (Y). In other words, the first and second tab portions 171 and 172 may be disposed at different positions in the third direction (Z).

Further, the first and second tab portions 171 and 172 may be spaced apart from the third and fourth tab portions 173 and 174 in the third direction (Z). For example, the third and fourth tab portions 173 and 174 may be disposed at different positions from each of the first and second tab portions 171 and 172 in the third direction (Z).

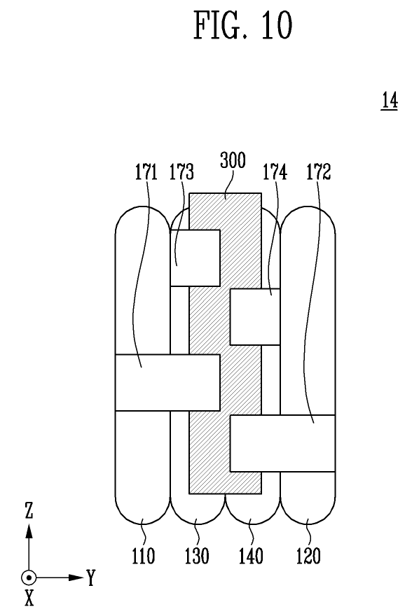

FIG. 10 is a side view schematically illustrating yet another aspect of FIG. 6.

Referring to FIG. 10, in a battery cell 14 according to yet another aspect, the plurality of tab portions 170 of the plurality of electrode assemblies 100 may be spaced apart from each other in the third direction (Z). For example, the first to fourth tab portions 171, 172, 173, and 174 may be spaced apart from each other in the third direction (Z). In other words, the first to fourth tab portions 171, 172, 173, and 174 may be disposed at different positions from each other in the third direction (Z).

Since this disclosure may be implemented in various forms, the scope of this disclosure is not limited to the above-described aspects. Therefore, as long as a modified aspect includes components of the appended claims of this disclosure, it should be considered to fall within the scope of this disclosure.

What is claimed is:

1. A battery cell comprising:
a plurality of electrode assemblies arranged side by side in a second direction intersecting a first direction, the plurality of electrode assemblies each comprising:
a plurality of electrode plates;
a separator disposed between the plurality of electrode plates; and
a plurality of tab portions protruding from the plurality of electrode plates in the first direction and arranged side by side in the second direction;
a case configured to accommodate the plurality of electrode assemblies; and
a current collector configured to be electrically connected to the plurality of electrode assemblies within the case,
wherein each of the plurality of tab portions comprises:
a first tab having a first inclination with respect to the first direction; and
a second tab having a second inclination with respect to the first direction and configured to be electrically connected to the first tab, and
wherein the first inclination and the second inclination differ from each other.

2. The battery cell of claim 1, wherein the current collector is disposed between a pair of the electrode assemblies disposed at outermost sides in the second direction.

3. The battery cell of claim 1, wherein one of the first tab and the second tab is closer to the current collector than the other of the first tab and the second tab.

4. The battery cell of claim 1, wherein one or more of the first tab and the second tab have a curved surface in at least a portion thereof.

5. The battery cell of claim 1, wherein the plurality of electrode assemblies further comprise another pair of electrode assemblies arranged between a pair of electrode assemblies disposed at outermost sides in the second direction.

6. The battery cell of claim 5, wherein the current collector and the other pair of electrode assemblies overlap each other in the first direction.

7. The battery cell of claim 5, wherein the plurality of tab portions are configured to form a tab bundle in which the plurality of tab portions contact each other.

8. The battery cell of claim 7, wherein the tab bundle is configured to be electrically connected to the current collector.

9. The battery cell of claim 7, wherein the tab bundle is bent in a direction toward the current collector and welded to the current collector.

10. The battery cell of claim 1, wherein the tab portions of a pair of the electrode assemblies disposed at the outermost sides in the second direction are disposed side by side in the second direction.

11. The battery cell of claim 10, wherein the tab portions of another pair of electrode assemblies disposed between the pair of electrode assemblies are disposed side by side in the second direction.

12. The battery cell of claim 1, wherein the tab portions of a pair of the electrode assemblies disposed at the outermost sides in the second direction are spaced apart from the tab portions of another pair of electrode assemblies disposed between the pair of electrode assemblies, in a third direction intersecting the first direction and the second direction.

13. The battery cell of claim 1, wherein the plurality of tab portions of the plurality of electrode assemblies are spaced apart from each other in a third direction intersecting the first direction and the second direction.

14. The battery cell of claim 1, wherein the plurality of tab portions comprise:
a first tab portion disposed at one of outermost sides in the second direction;
a second tab portion disposed at the other of the outermost sides in the second direction;
a third tab portion disposed between the first tab portion and the second tab portion and adjacent to the first tab portion; and
a fourth tab portion disposed between the first tab portion and the second tab portion and adjacent to the second tab portion.

15. The battery cell of claim 14, wherein the first tab portion and the second tab portion are each bent twice in different directions.

16. The battery cell of claim 14, wherein the third tab portion and the fourth tab portion are each bent twice in the same direction.

17. The battery cell of claim 14, wherein the first tab of the first tab portion is disposed inward of the second tab of the first tab portion in the second direction,
wherein the first tab of the second tab portion is disposed inward of the second tab of the second tab portion in the second direction,
wherein the first inclination of the first tab of the first tab portion is less than the second inclination of the second tab of the first tab portion, and
wherein the first inclination of the first tab of the second tab portion is less than the second inclination of the second tab of the second tab portion.

18. The battery cell of claim 14, wherein the first tab of the third tab portion is disposed outward of the second tab of the third tab portion in the second direction,
wherein the first tab of the fourth tab portion is disposed outward of the second tab of the fourth tab portion in the second direction,
wherein the first inclination of the first tab of the third tab portion is less than the second inclination of the second tab of the third tab portion, and
wherein the first inclination of the first tab of the fourth tab portion is less than the second inclination of the second tab of the fourth tab portion.

19. The battery cell of claim 1, wherein the case comprises:
an accommodating body including an opening in one surface thereof, and accommodating the electrode assemblies through the opening; and
a cap assembly configured to be coupled to the accommodating body to cover the opening.

20. The battery cell of claim 19, wherein the current collector comprises:
a first portion configured to be electrically connected to the plurality of tab portions; and
a second portion bent from the first portion and configured to be electrically connected to the cap assembly.
